(19) United States
(12) Patent Application Publication
(10) Pub. No.: US 2009/0107610 A1
(43) Pub. Date: Apr. 30, 2009

(54) Tyre for vehicle wheel comprising a particular carcass structure

(76) Inventor: Renato Caretta, Gallarate (Varese) (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/155,736

(22) Filed: Jun. 9, 2008

Related U.S. Application Data
(63) Continuation-in-part of application No. 11/201,161, filed on Aug. 11, 2005, now abandoned.
Application No. 11/201,161 is a division of application No. 09/937,601, filed on Sep. 28, 2001, now Pat. No. 6,945,295.
(60) Provisional application No. 60/190,526, filed on Mar. 20, 2000.

(30) Foreign Application Priority Data
Jan. 28, 2002 (EP) 00830058.4

(51) Int. Cl. B60C 9/02

(52) U.S. Cl. 152/548

(57) ABSTRACT

A tyre for a vehicle wheel includes a carcass structure, a belt structure, a tread band, and sidewalls laterally applied to opposite sides of the carcass structure. The carcass structure includes at least one carcass ply with a first and second series of strip segments and a pair of annular reinforcing structures. In one embodiment, each of the pair of annular reinforcing structures includes a first annular insert having opposed axial surfaces and being positioned between respective lateral portions of the first series of strip segments and respective diverging lateral portions of the second series of strip segments. In this embodiment, no filling body is positioned between the respective lateral portions of the first series of strip segments and the respective diverging lateral portions of the second series of strip segments. In an alternative embodiment, each of the pair of annular reinforcing structures includes a first annular insert and a filling body, the first annular insert and the filling body each having opposed axial surfaces and being positioned between the respective lateral portions of the first series of strip segments and the respective diverging lateral portions of the second series of strip segments.

### CROSS-REFERENCES TO RELATED APPLICATIONS

This application is a continuation-in-part of U.S. patent application Ser. No. 11/201,161, filed Aug. 11, 2005, which is a divisional of U.S. patent application Ser. No. 09/937,601, filed Sep. 28, 2001, which is a national stage entry under 35 U.S.C. § 371 of International Application No. PCT/EP0100644, filed Jan. 22, 2001, in the European Patent Office. Additionally, Applicant claims the right of priority under 35 U.S.C. § 119(a)-(d) based on Patent Application No. 00830058.4, filed Jan. 28, 2002, in the European Patent Office. Further, Applicant claims the benefit under 35 U.S.C. § 119(e) based on prior-filed, copending U.S. Provisional Patent Application No. 60/190,526, filed Mar. 20, 2000, in the U.S. Patent and Trademark Office, the contents of all of which are relied upon and incorporated herein by reference.

### BACKGROUND OF THE INVENTION

1. Field of the Invention

The present invention relates to a carcass structure for tyres for vehicle wheels, comprising at least, in one embodiment, a single-ply carcass having a first and a second series of strip-like segments consecutively arranged along the circumferential development of the carcass structure, each of said which extends according to a substantially “U” shaped conformation and comprises at least two filiform elements positioned longitudinally and parallel to each other and at least partially coated by at least a layer of raw elastomeric material, and a pair of annular reinforcing structures each engaged in proximity to a respective interior circumferential edge of the carcass ply.

2. Description of the Related Art

The manufacture of tyres for vehicle wheels entails the formation of a carcass structure essentially composed by one or more carcass plies shaped according to a substantially toroidal configuration and presenting their axially opposite lateral edges engaged to respective annular reinforcing elements, usually called “bead rings”.

On the carcass structure is applied, in circumferentially exterior position, a belt structure comprising one or more belt strips shaped as a closed loop, essentially composed by textile or metallic cords suitably oriented relative to each other and to the cords belonging to the adjacent carcass plies.

In a position circumferentially exterior to the belt structure, a tread band is then applied, normally constituted by a strip of elastomeric material of suitable thickness.

It should be specified that, for the purposes of the present description, the term “elastomeric material” means the rubber compound in its entirety, i.e. the set formed by at least a polymeric base suitably amalgamated with reinforcing fillers and/or process additives of various kinds.

Lastly, on the opposite sides of the tyre being manufactured, a pair of sidewalls is applied, each of which covers a lateral portion of the tyre lying between a so-called shoulder area, located in proximity to the corresponding lateral edge of the tread band, and a so-called bead located in correspondence with the corresponding bead ring.

Traditional manufacturing methods essentially provide for the tyre components listed above to be first produced separately from each other, then assembled in a tyre manufacturing phase.

For instance, the manufacture of the carcass ply or plies to be associated to the bead rings to form the carcass structure requires first that, through an extrusion and/or calendering process, a rubberized fabric be produced comprising continuous textile or metallic cords, arranged longitudinally. This rubberized fabric is subjected to a transverse cutting operation to produce segments of predetermined dimensions, which are subsequently united to originate a continuous belt-like semi-finished product, having transversely positioned parallel cords.

This manufactured item must then be cut into segments of a length correlated to the circumferential development of the carcass to be produced.

Manufacturing methods have also been proposed which, instead of producing semi-finished products, produce the carcass structure directly during the tyre manufacturing phase.

For instance, U.S. Pat. No. 5,453,140 describes a method and an apparatus that form a carcass ply starting from a single cord previously wound on a reel.

According to the method and the apparatus described in this patent, at each operative cycle of the apparatus the cord drawn from the reel by means of motorized driving rollers and kept tensioned by means of a pneumatic tensioning system is cut to measure to obtain a segment of predefined length.

The cord segment is drawn by a gripping element mounted on a belt wound on motorized pulleys to be laid transversely onto the exterior surface of a toroidal support.

The ends of the segment are then engaged by belt folding organs operating on opposite sides of the toroidal support to apply the cord segment radially onto the toroidal support itself by means of cursor elements which act in the manner of fingers along the lateral portions of the segment.

The repetition of the operative cycle described above leads to the laying of many cord segments in circumferential side by side relationship until the entire circumferential development of the toroidal support is involved.

Of necessity, the toroidal support is previously coated with a layer of raw rubber which has a dual function of adhering to the cords laid thereon in order adequately to hold them according to a fixed positioning, and of constituting an interior coating, impermeable to air, in the finished tyre.

Tyres obtained through this manufacturing method present a carcass structure wherein the carcass ply or plies are constituted by single cords each presenting two lateral portions axially distanced from each other and oriented radially to the axis of rotation of the tyre, and a crown portion extending in radially exterior position between the lateral portions.

Within the scope of the manufacture of the carcass structure, it is also known that in proximity to each of the beads of the tyre, the opposite ends of the single cords constituting a carcass ply are located, with alternating sequence, in axially opposite positions relative to an annular anchoring element constituting the aforesaid bead ring, shaped in the manner of an annulus composed by wire turns radially superposed on one another, as can be observed from the Patent EP 0 664231 and from U.S. Pat. No. 5,702,548.

The cords that compose the carcass ply or plies, however, are positioned substantially according to the neutral axis of bending resistance of the respective bead. In this circumstance, the structural strength of the beads must necessarily be entrusted to the rigidity of filling inserts made of very hard elastomeric material incorporated in the structure of the bead, whose behavior is affected by temperature variations due both to environmental factors, and to the stresses induced during normal operation.

In Patent FR 384 231, the production is proposed of a carcass structure by the laying, onto a toroidal support, of a series of rectangular bands made of rubberized fabric circumferentially positioned side by side one after the other and arranged according to radial planes relative to the geometric axis of the supporting drum itself. The laying of the bands is conducted in such a way that the terminal edges of two non-consecutive bands are partially covered by the terminal edges of the band interposed between them.

The spaces existing between the terminal edges covered by the bands are filled by means of trapezoidal inserts applied to the terminal edges of the band superposed thereon. The laying of the bands is effected according to several superposed layers, in a number correlated to the thickness to be conferred to the carcass structure. The presence of the aforesaid trapezoidal inserts determines a thickening of the carcass structure in the areas of the beads, providing it with double the thickness measurable in the rim.

U.S. Pat. No. 4,248,287 describes a method according to which the formation of the carcass structures provides for the laying, on a toroidal drum, of a plurality of layers each formed by radial strips composed by rubberized wires and set circumferentially side by side relative to each other. Once the laying is complete, two bead rings are applied in the bead area, around which bead rings are then folded back the terminal edges of the carcass layers formed by the radial strips.

### SUMMARY OF THE INVENTION

In accordance with the present invention, it was found that within the scope of the manufacture of a tyre surprising advantages can be obtained if the carcass ply or plies are produced by laying at least two distinct series of strip-like segments and providing, in each of the annular structures reinforcing the beads, two annular inserts that grip the terminal edges belonging respectively to the segments of one of said series.

More specifically, one embodiment of the invention relates to a single-ply carcass structure for tyres characterized in that each of said annular reinforcing structures comprises at least a primary portion presenting an axially interior side oriented towards terminal edges of the segments belonging to the first series and an axially exterior side oriented towards terminal edges of the segments belonging to the second series, and at least an additional portion positioned against the terminal edges of the strip-like segments belonging to the second series, to the opposite side relative to the primary portion of the annular structure itself; wherein said primary portion comprises a first annular insert shaped substantially in the manner of an annulus positioned coaxially to the carcass structure and adjacently to an interior circumferential edge of the carcass ply, said first annular insert being formed by at least an elongated element extending according to concentric turns; a filling body made of elastomeric material presenting a side joined to the first annular insert; at least a second annular insert substantially shaped in the manner of an annulus, formed by at least an elongated element extending according to concentric turns and positioned coaxially to the carcass structure in a position set axially side by side to the filling body and laterally opposite relative to the first annular insert; and wherein said additional portion comprises at least a third annular insert shaped substantially in the manner of an annulus, formed by at least an elongated element extending according to concentric turns and positioned coaxially to the carcass structure and adjacently to an interior circumferential edge of the carcass ply.

Preferably, said first and second series of strip-like segments in the single-ply carcass structure are positioned in a mutually alternated sequence along the entire circumferential development of the carcass structure.

It is also preferably provided for each of said strip-like segments to present two lateral portions developing substantially towards a geometric axis of said carcass structure in positions that are mutually distanced in the axial direction, and a crown portion extending in a radially exterior position between the lateral portions; the crown portions belonging respectively to the segments of the first and second series being set mutually side by side along the circumferential development of the carcass structure.

Preferably, the third and second annular inserts present each a lesser radial extension than the radial extension of the first annular insert. More specifically, the third annular insert presents a lesser radial extension, measuring between ⅓ and ⅔ of the radial extension of the first annular insert.

It may also be provided for the second annular insert to present a lesser radial extension measuring between ⅓ and ⅔ of the radial extension of the first annular insert.

Preferably, said carcass structure further comprises an auxiliary filling body made of elastomeric material, situated in an axially exterior position against said at least one carcass ply and extending in radial separation from said third annular insert.

Said auxiliary filling body preferably presents a hardness substantially equal to that of the filling body belonging to the primary portion.

In a first alternative embodiment, each of the pair of annular reinforcing structures includes a first annular insert having opposed axial surfaces and being positioned between the respective lateral portions of the first series of strip segments and the respective diverging lateral portions of the second series of strip segments, the opposed axial surfaces of the first annular insert abutting the respective lateral portions of the first and second series of strip segments. Moreover, between a radially outermost end of the first annular insert and the respective crown portions of the first and second series of strip segments, the diverging lateral portions of the second series of strip segments are in overlapping contact with the lateral portions of the first series of strip segments. In this embodiment, however, no filling body is positioned between the respective lateral portions of the first series of strip segments and the respective diverging lateral portions of the second series of strip segments. In other words, in the first alternative embodiment, the respective lateral portions of the first series of strip segments and the diverging lateral portions of the second series of strip segments define a space therebetween, and the opposed axial surfaces of the first annular insert abut the respective lateral portions of the first and second series of strip segments, with the first annular insert occupying essentially the entirety of the space.

In addition, in the first alternative embodiment, each of the pair of annular reinforcing structures may further include a second annular insert and/or a third annular insert. The second annular insert may be laterally opposed from the first annular insert and positioned in conforming relation to, and axially inboard of, the respective lateral portions of the first series of strip segments. The third annular insert may be laterally opposed from the first annular insert and positioned in conforming relation to, and axially outboard of, the respective lateral portions of the second series of strip segments.

In a second alternative embodiment, each of the pair of annular reinforcing structures includes a first annular insert and a filling body, the first annular insert and the filling body each having opposed axial surfaces and being positioned between the respective lateral portions of the first series of strip segments and the respective diverging lateral portions of the second series of strip segments. The respective opposed axial surfaces of the first annular insert and the filling body abut the respective lateral portions of the first and second series of strip segments. In other words, in the second alternative embodiment, the respective lateral portions of the first series of strip segments and the diverging lateral portions of the second series of strip segments define a space therebetween, and the respective opposed axial surfaces of the first annular insert and the filling body abut the respective lateral portions of the first and second series of strip segments, and the first annular insert and the filling body together occupy essentially the entirety of the space.

In addition, each of the pair of annular reinforcing structures may further include a second annular insert and/or a third annular insert. The second annular insert may be laterally opposed from the first annular insert and positioned in conforming relation to, and axially inboard of, the respective lateral portions of the first series of strip segments. The first annular insert and the second annular insert radially extend to terminal ends of the respective lateral portions of the first and second series of strip segments.

The second alternative embodiment may further include a third annular insert laterally opposed from the first annular insert and positioned in conforming relation to, and axially outboard of, the respective lateral portions of the second series of strip segments.

The first and second alternative embodiments described above may further include either a single-ply carcass structure or a double-ply carcass structure.

The invention further relates to a high performance, low profile tyre comprising a carcass structure presenting one or more of the particular features described.

### BRIEF DESCRIPTION OF THE DRAWINGS

Further features and advantages shall become more readily apparent from the detailed description of a preferred, but not exclusive, embodiment of a carcass structure for tyres for vehicle wheels, according to the present invention. The description shall be made below with reference to the accompanying drawings, provided purely by way of non-limiting indication, in which:

FIG. 1 is an interrupted and cut out view of a tyre provided with a carcass structure manufactured in accordance with the present invention;

FIG. 2 is a diagram showing the manufacture of a continuous strip-like element destined to form the carcass ply or plies;

FIG. 3 shows, in cross section view, an embodiment of the aforesaid strip-like element;

FIG. 4 shows an interrupted perspective view of a schematic representation of the laying sequence of a first series of strip-like segments in order to form a carcass ply of the tyre according to the invention;

FIG. 5 shows an interrupted perspective view of a primary portion of an annular reinforcing structure applied laterally on terminal edges of the strip-like segments belonging to the first series;

FIG. 6 shows an interrupted perspective view of the carcass structure after the application of a third annular insert and of an auxiliary filling body comprised in an additional portion of the bead reinforcing structure;

FIG. 7 is a cross section showing a tyre according to the invention;

FIG. 8 illustrates a partial cross section of a first alternative tyre configuration without a filling body interposed between the first and second series of strip-like segments of a double-ply carcass structure;

FIG. 9 is a cross section of the first alternative tyre configuration in FIG. 8 mounted on a rim section;

FIG. 10 illustrates a partial cross section of another first alternative tyre configuration without a filling body interposed between the first and second series of strip-like segments of a single-ply carcass structure;

FIG. 11 is a cross section of the other first alternative tyre configuration in FIG. 10 mounted on a rim section;

FIG. 12 is partial cross section of a second alternative tyre configuration with a filling body and only one annular insert interposed between the first and second series of strip-like segments of a double-ply carcass structure;

FIG. 13 is a cross section of the second alternative tyre configuration in FIG. 12 mounted on a rim section;

FIG. 14 is partial cross section of another second alternative tyre configuration with a filling body and only one annular insert interposed between the first and second series of strip-like segments of a single-ply carcass structure; and

FIG. 15 is a cross section of the other second alternative tyre configuration in FIG. 14 mounted on a rim section.

### DETAILED DESCRIPTION OF THE PREFERRED EMBODIMENTS

With reference to the aforementioned figures, the number 1 globally indicates a tyre for wheels of vehicles, having a carcass structure 2 manufactured in accordance with the present invention.

In the various embodiments shown in the drawings, the tyre 1 is a tyre for motor-vehicles, for example, cars. Motor-vehicle tyres are distinguishable from other types of tyres based on their transverse curvature. The transverse curvature is usually identified by a ratio of a distance between a radially outermost point of the tread and a line passing through laterally opposite extremities of the same tread measured in an equatorial plane of the tyre, to a distance measured along a tyre chord between the laterally opposite extremities of the tread. In motor-vehicle tyres the curvature ratio value is generally between 0.01 and 0.1, for example, about 0.05. By comparison, the curvature ratio value for two-wheeled vehicles may be as high as 0.15.

The carcass structure 2 has at least a first carcass ply 3 shaped according to a substantially toroidal configuration and engaged, by means of its opposite circumferential edges, to a pair of annular structures 4, each of which may be inextensible, and once the tyre has been completed, is located in the area usually identified with the name of “bead”.

On the carcass structure 2 is applied, in circumferentially exterior position, a belt structure 5 comprising one or more belt strips 6a, 6b and 7. To the belt structure 5 is circumferentially superposed a tread band 8 whereon, following a molding operation performed simultaneously with the curing of the tyre, longitudinal and/or transverse recesses 8a are obtained, arranged to define a desired “tread design”.

The tyre further comprises a pair of so-called “sidewalls” 9 applied laterally at opposite sides onto the carcass structure 2.

The carcass structure 2 can be coated on its inner walls by a sealing layer 10 or so-called “liner”, essentially constituted by a layer of elastomeric material impermeable to air able to guarantee the hermetic tightness of the inflated tyre.

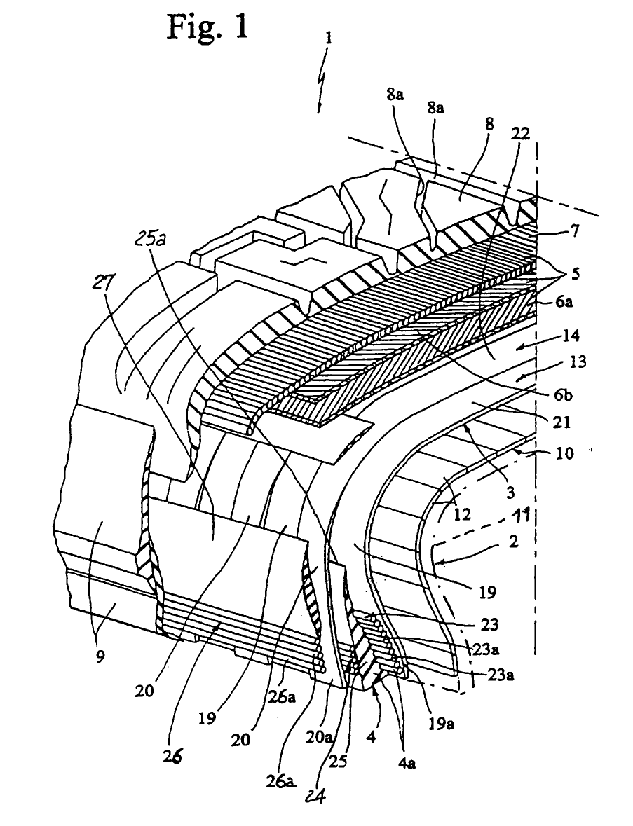

The assembly of the components listed above, as well as the manufacture of one or more thereof, takes place with the aid of a toroidal support 11, schematically indicated in dashed lines in FIG. 1, shaped according to the configuration of the inner walls of the tyre to be manufactured.

The toroidal support 11 can have smaller dimensions than the finished tyre, according to a linear measurement preferably ranging between 2% and 5%, taken, by way of indication, along the circumferential development of the support itself in correspondence with its equatorial plane, which coincides with the equatorial plane of the tyre itself.

The toroidal support 11, neither described nor illustrated in detail because it is not particularly relevant for the purposes of the invention, can for instance be constituted by a collapsible drum or by an inflatable tube suitably reinforced to assume and maintain the desired toroidal shape in the inflated condition.

All this having been stated, the manufacture of the tyre 1 entails first the formation of the carcass structure 2, which starts with the possible formation of the sealing layer 10.

This sealing layer 10 can advantageously be obtained by circumferentially winding about the toroidal support 11 at least a ribbon-like band 12 made of elastomeric material impermeable to air, produced by a strainer and/or by a calender situated in the vicinity of the toroidal support itself. As can be observed from FIG. 1, the winding of the ribbon-like band 12 takes place substantially according to circumferential turns consecutively set by side to follow the cross section profile of the outer surface of the toroidal support 11.

For the purposes of the present invention the term cross section profile means the configuration presented by the semi-section of the toroidal support 11 sectioned according to a plane radial to its own geometric axis of rotation, not shown in the drawings, coinciding with the geometric axis of rotation of the tyre and, hence, of the carcass structure 2 being manufactured.

The carcass ply 3 is formed directly on the toroidal support 11 by laying, as shall become clearer farther on, a first and a second series of strip-like segments 13, 14, obtained from at least a continuous strip-like element 2a preferably presenting a width ranging between 3 mm and 15 mm. The carcass structure may be a single-ply carcass or a double-ply structure.

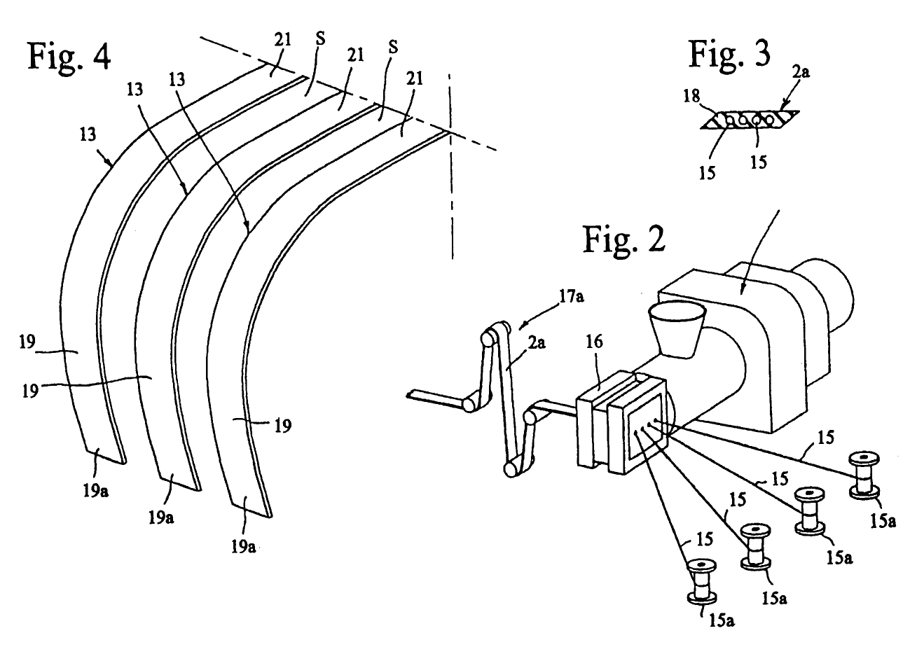

As FIG. 2 shows, the preparation of the continuous strip-like element 2a essentially provides for one or more filiform elements 15, and preferably three to ten filiform elements 15, fed by respective reels 15a, to be guided through a first strainer 16 associated to an extrusion apparatus 17 which feeds raw elastomeric material through the strainer itself.

It is specified that, for the purposes of the present description, the term “strainer” means the part of the extrusion apparatus identified in the art also with the term “extrusion head”, provided with a so-called “die” traversed by the product being processed in correspondence with an exit port shaped and dimensioned according to the geometric and dimensional characteristics to be given to the product itself.

The elastomeric material and the filiform elements 15 are intimately united inside the strainer 16, generating at the output thereof the continuous strip-like element 2a, formed by at least a layer of elastomeric material 18 in whose thickness are incorporated the filiform elements themselves.

Depending on requirements, it is possible to guide the filiform elements 15 into the strainer 16 in such a way that they are not integrally incorporated into the layer of elastomeric material 19 but emerge from one or both its surfaces.

The filiform elements 15 can, for instance, be constituted each by a textile cord with a diameter preferably ranging between 0.6 mm and 1.2 mm, or by a metal cord, with a diameter preferably ranging between 0.3 mm and 2.1 mm.

Advantageously, if required, the filiform elements 15 can be positioned in the continuous strip-like element 2a in such a way as to provide unexpected characteristics of compactness and homogeneity to the carcass ply 3 thereby obtained.

For this purpose, the filiform elements 15 can, for instance, be arranged according to a density exceeding six filiform elements per centimeter, measured circumferentially on the carcass ply 3 in proximity to the equatorial plane of the tyre 1. It is in any case preferably provided for the filiform elements 15 to be positioned in the strip-like element 2a according to a distance between their respective centers no smaller than 1.5 times the diameter of the filiform elements themselves, in order to allow for adequate rubberizing between adjacent wires.

The continuous strip-like element 2a exiting the strainer 16 can advantageously be guided, possibly through an accumulating-compensating device 17a, onto a laying apparatus whose structural and operating characteristics are described more in detail in document EP 928680 A, in the name of the same Applicant, whose content is considered enclosed herein.

This laying apparatus is able sequentially to cut the continuous strip-like element 2a to obtain strip-like segments 13, 14 of predetermined length.

The execution of the cutting of each strip-like segment 13, 14 is immediately followed by the laying of the segment onto the toroidal support 11, shaping the strip-like segment according to a “U” configuration around the cross section profile of the toroidal support itself, in such a way that in the strip-like segment 13, 14 can be identified two lateral portions 19, 20 radially developing towards the axis of the toroidal support 11, in positions that are axially distanced from each other, and a crown portion 21, 22 extending in radially exterior position between the lateral portions themselves.

The stickiness of the raw elastomeric material forming the layer 18 which coats the filiform elements 15 assures the stable adhesion of the strip-like segments 13, 14 on the surfaces of the toroidal support 11, also in the absence of the sealing layer 10 on the toroidal support itself. More in particular, the adhesion described above is manifested as soon as the strip-like segment 13, 14 comes in contact with the toroidal support 11 in a radially exterior area of its cross section profile.

In addition or instead of the exploitation of the natural stickiness of the elastomeric material, as described above, the holding of one or more of the strip-like segments 13, 14 on the toroidal support 11 can be obtained by means of an aspirating action produced through one or more suitable holes provided on the toroidal support itself.

The toroidal support 11 can be actuated in angular rotation according to a stepped motion in synchrony with the actuation of the aforesaid laying apparatus, in such a way that each cutting action on each strip-like segment 13, 14 is followed by its laying in a circumferentially distanced position relative to the previously laid segment 13, 14.

More specifically, the rotation of the toroidal support 11 takes place according to an angular pitch whereto corresponds a circumferential displacement equal to a multiple of, and more precisely to double, the width of each strip-like segment 13, 14.

It should be noted that, for the purposes of the present description, unless otherwise indicated, the term “circumferential” refers to a circumference lying in the equatorial plane and in proximity to the exterior surface of the toroidal support 11.

According to one embodiment of the present invention, the operative sequence described above is such that a first complete revolution of the toroidal support 11 about its own axis determines the laying of the first series of strip-like segments 13 in a single-ply carcass structure, circumferentially distributed according to a circumferential pitch equal to twice the width of each of them. Therefore, as FIG. 4 clearly shows, between one and the other of the segments belonging to the first series an empty space “S” is left which, at least in correspondence with the crown portions 21 of the segments themselves, equals the latter in width.

The manufacture of a carcass structure 2 then proceeds with the phase whereby the aforementioned annular structures 4, and more specifically primary parts 4a thereof, are applied in proximity to each of the interior circumferential edges of the carcass ply 3 being manufactured, in order to obtain the carcass areas, known as “beads”, especially destined to guarantee the anchoring of the tyre to a corresponding mounting rim 29.

The primary portion 4a of each of the aforesaid annular reinforcing structures 4 comprises a first annular insert 23, which may be circumferentially inextensible, shaped substantially in the manner of a circular crown concentric to the geometric axis of rotation of the toroidal support 11 and located in a circumferentially interior position against terminal edges 19a presented by the strip-like segments 13 belonging to the first series.

The first annular insert 23 is composed by at least a metallic elongated element wound according to multiple, substantially concentric, turns 23a. The turns 23 can be defined by a continuous spiral or by concentric rings formed by respective elongated elements.

The first annular insert 23 is combined with a second annular insert 24, which is, for example, circumferentially inextensible and extends substantially according to a respective annulus coaxially set side by side relative to the first annular insert 23 at an appropriate distance therefrom.

The second annular insert 24 is also preferably composed by at least a metallic elongated element wound according to multiple, substantially concentric, turns 24, which can be defined by a continuous spiral or by concentric loops formed by respective elongated elements.

The second annular insert 24 presents a radial extension, determined by the difference between the minimum inner radius and the maximum outer radius of the annular insert itself, that is preferably lesser than, and more specifically ranging between ⅓ and ⅔ of, the radial extension of the first annular insert 23.

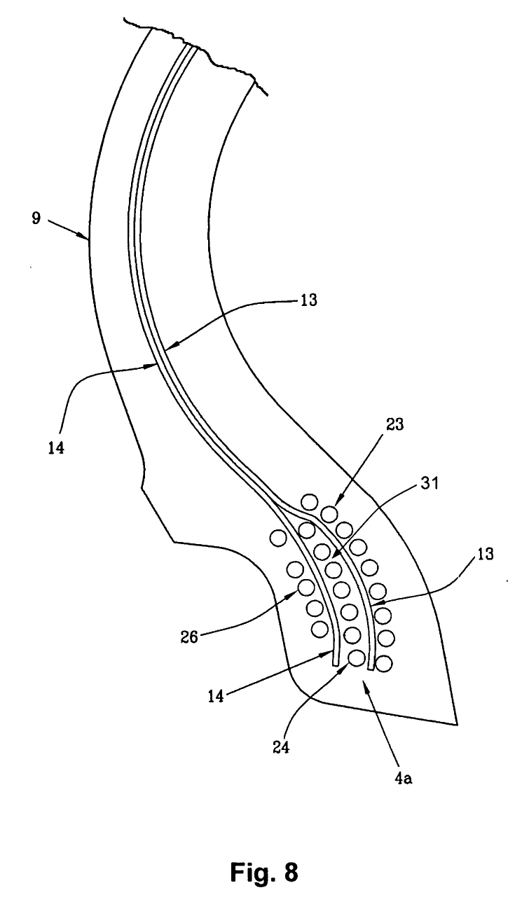

Between the first and the second annular insert 23, 24 is interposed a filling body 25 made of elastomeric material, preferably thermoplastic, having hardness ranging between 48° and 55° Shore D, measured at a temperature of 23° C. The filling body is normally provided in each of the beads in order to fill a space between several ply portions lying against axially opposite sides of an annular anchoring insert in order to avoid or at least reduce air entrapment within the bead of the tyre. In addition, filling bodies generally control the rigidity of the tyre in the region of the bead so as to obtain a rigidity gradually decreasing from the annular anchoring insert towards a radially external region of the tyre. However, as will be discussed below, FIGS. 8-11 disclose alternate tyre configurations with the filling body eliminated altogether.

With continued reference to the embodiment depicted in FIGS. 1-7, the manufacture of the first portions 4a can entail the formation of the first filling body 25 separately from the first annular insert 23, and the subsequent union of the first filling body itself with the first annular insert previously applied against the terminal edges 19a of the strip-like segments 13 laid onto the toroidal support 11.

More specifically, in accordance with a preferential embodiment, the first annular insert 23 is manufactured directly against the terminal edges 19a of the strip-like segments 13 by laying at least an elongated element according to concentric turns 23a arranged in mutual side-by-side relationship, according to circumferences with progressively increasing diameter about their geometric winding axis, corresponding to the axis of rotation of the finished tyre.

The winding of the filiform element can be effected with the possible aid of rollers or other convenient means acting in contrast with the surface of the toroidal support 11.

The stickiness of the elastomeric layer 18 that coats the strip-like segments 13 belonging to the first series, as well as of the possible sealing layer 10 previously laid on the drum itself, assure the stable positioning of the individual turns 23a being formed.

Subsequently, the filling body 25 can in turn be formed directly against the annular anchoring insert 23, for instance applying a continuous strip made of elastomeric material exiting a strainer positioned adjacently to the drum 11. The continuous strip can present the final section conformation of the filling body 25, already as it exits the respective strainer. Alternatively, the continuous strip will present a smaller cross section than that of the filling body, and the latter shall be obtained applying the strip itself according to multiple turns set side by side and/or superposed, to define the filling body 25 in its final configuration.

Subsequently, the second insert 24 may be manufactured directly on the previously formed filling body 25 by laying an elongated element according to concentric turns 24a, in a similar manner to the one described with reference to the first insert 23.

After the application of the primary portions 4a of the respective annular reinforcing structures 4, the formation of the first carcass ply 3 is completed by laying the second series of strip-like segments 14 obtained by cutting to measure the continuous strip-like element 2a and applied on the toroidal support 11 in a manner similar to the one described for the strip-like segments 13 belonging to the first series.

In the single-ply carcass structure, each segment 14 belonging to the second series is laid according to a “U” conformation around the cross section profile of the toroidal support 11, between two consecutive segments 13 belonging to the first series. More specifically, each segment 14 belonging to the second series presents the respective crown portion 22 circumferentially interposed between the crown portions 21 of the segments 13 belonging to the first series, to fill the space “S” existing between them, and a pair of lateral portions 20 which bring the terminal edges 20a of the segment itself in superposition to the respective primary portions 4a of the annular reinforcement structures 4, in axially opposite positions relative to the terminal edges 19a of the segments 13 belonging to the first series.

In other words, the primary portion 4a of each annular reinforcing structure 4, having a section profile shaped substantially in the manner of a triangle with its vertex oriented away from the axis of the tyre, presents an axially interior side oriented towards the terminal edges of the strip-like segments 13 belonging to the first series, and an axially exterior side oriented towards the terminal edges 20a of the segments 14 belonging to the second series.

In the single-ply carcass structure, the lateral portions 20 of each segment 14 belonging to the second series can also partially cover the lateral portions 19 of two consecutive segments 13 belonging to the first series, each in a length lying between the radially exterior edge 25a of the respective primary portion 4a and the transition area between the lateral portion itself and the crown portion 21.

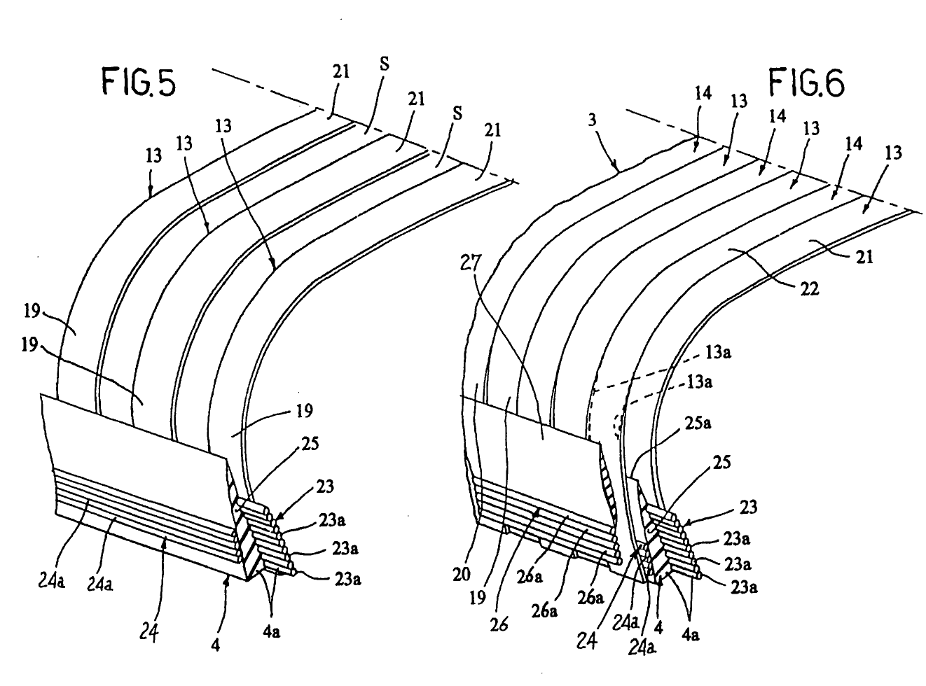

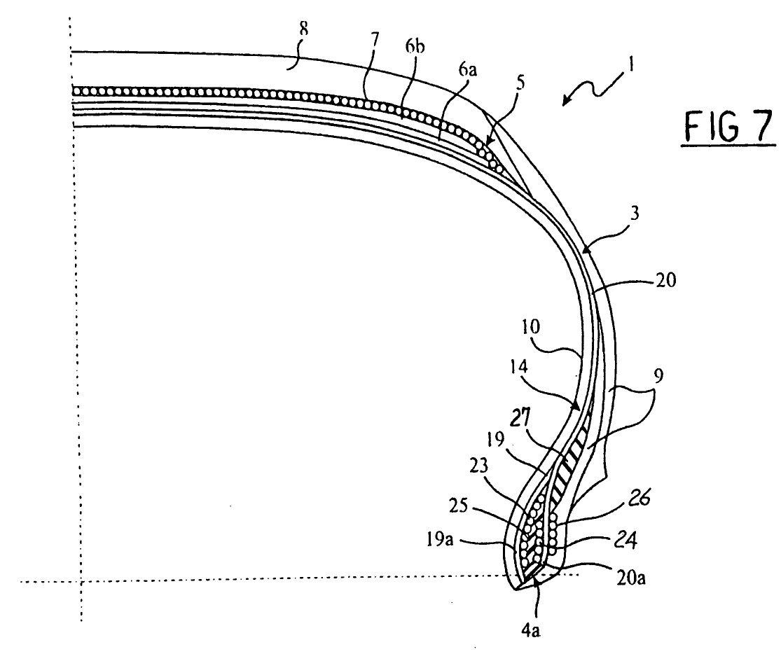

The superposition areas of the strip-like segments 13 belonging to the first series are indicated as 13a in FIG. 6.

Due to the mutual convergence between the contiguous lateral portions 19, 20, oriented radially to the geometric axis of the toroidal support 11, the superposition or covering of the lateral portions 19 of the segments 13 belonging to the first series, i.e. the circumferential amplitude of the superposition areas 13a, progressively diminishes starting from a maximum value in proximity to the radially exterior edge 25a of the primary portion 4a of each annular reinforcing structure 4, down to a value of zero in correspondence with the transition area between the lateral portions 19, 20 and the crown portions 21, 22.

If, in proximity to the beads, a more homogeneous distribution of the filiform elements 15 respectively composing the segments 13, 14 of the first and of the second series is to be obtained, a deflection step can be executed sequentially on the continuous strip-like element 2a in the areas of its longitudinal development corresponding to the extremities of the strip-like segments 13, 14 to be obtained following the cutting actions. In this way, on the development of each strip-like segment 13, 14, areas with increased width are defined, positioned in correspondence with the interior circumferential edges of the carcass ply 3 thus formed.

The deflection action causes a reduction in the thickness of the elastomeric layer 18 and an increase in the width of the strip-like element 2a with the consequent mutual separation of the filiform elements 15. In so doing, the terminal edges 19a, 20a of each segment 13, 14 can be widened until they present, in correspondence with the circumferentially interior extremities, a width that is twice that of the crown portions 21,22, such as to coat completely the respective interior and exterior sides of the primary portions 4a of each annular reinforcing structure 4.

After laying the strip-like segments 14 belonging to the second series in the manner described above, the formation of the annular bead reinforcing structures 4 is completed.

For this purpose, for each of the reinforcing structures 4, a third annular insert 26 is formed, which is, for example, circumferentially inextensible and extends substantially according to a respective annulus set coaxially side by side relative to the second annular insert 24.

The third annular insert 26, too, is preferably composed by at least a metallic elongated element wound according to multiple, substantially concentric turns 26a, which can be defined by a continuous spiral or by concentric loops formed by respective elongated elements. Moreover, the third annular insert also preferably has a radial extension, determined by the difference between the minimum inner radius and the maximum outer radius of the annular insert itself, that is lesser than, and preferably ranges between ⅓ and ⅔ of the radial extension of the first annular insert 23.

The third insert 26 thus constitutes an additional portion of the reinforcing structure 4, which is applied against the terminal edges 20a of the strip-like segments 14 belonging to the second series, for instance by effecting the winding of the respective elongated element directly against the terminal edges themselves.

Following this operation, each of the terminal edges 20a of the segments 14 belonging to the second series is advantageously enclosed between the second annular insert 24 and the third annular insert 26.

Also provided is the addition of an auxiliary filling body 27 made of elastomeric material placed in an axially exterior position against the carcass ply 3 and extending radially away from said third annular insert 26.

Preferably, the hardness of the auxiliary filling body 27 is substantially equal to the hardness of the filling body 25.

In radial tyres, a belt structure 5 is usually applied to the carcass structure 2.

This belt structure 5 can be obtained in any manner convenient to the person versed in the art and, in the illustrated embodiment, essentially comprises a first and a second belt strip 6a, 6b presenting cords with respectively crossed orientation. To the belt strips is superposed an auxiliary belt strip 7 for instance obtained by winding at least a continuous cord according to turns set axially side by side on the first and second belt strip 6a, 6b.

On the belt structure 5 are then applied the tread band 8 and the sidewalls 9, also obtainable in any manner found convenient by the person versed in the art.

Embodiments of a belt structure, of sidewalls and of a tread band that can be advantageously adopted for the complete manufacture of the tyre 1 on the toroidal support 11 are described in the document EP 919406 A in the name of the same Applicant.

The tyre 1 thus manufactured can now be subjected, after its removal from the support 11, to a curing phase which can be conducted in any known and conventional manner.

The present invention achieves important advantages.

The subject carcass structure can be obtained directly on a toroidal support whereon, advantageously, the entire tyre can be formed, with considerable reduction in processing times compared to the method described in document U.S. Pat. No. 5,362,343.

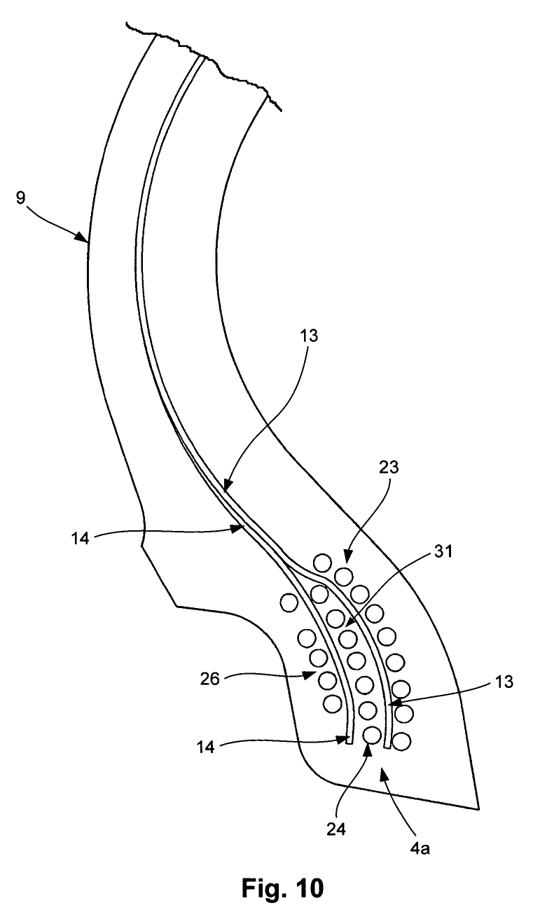

The constructive and structural conception of the subject tyre, especially with reference to its carcass structure 2, provides considerable improvements in terms of structural resistance, especially in proximity to the sidewalls and beads, where greater structural strength is normally required, as well as behavior, particularly in relation to the effects of the drift thrusts that manifest themselves during travel in curves, while benefiting from all the advantages typically connected to a single-ply carcass structure, as illustrated in FIGS. 10, 11, 14, and 15.

In particular, the constructive features of the annular structures 4 and the manner whereby they are integrated in the carcass ply are such as further to enhance the excellent structural resistance of the tyre 1 in the areas of the beads and sidewalls.

The presence of the annular inserts 23, 24 and 26, are intimately joined to the carcass ply 3, provides an excellent “bond” with the filiform elements 15 belonging to the different series of strip-like segments. The carcass structure 2 is thereby further strengthened in the areas corresponding to the beads of the tyre 1 without requiring, for this purpose, the use of additional strip-like inserts, usually called “flippers”, wound in a loop around the annular reinforcing structures 4, used instead in the prior art.

In particular the presence of the second and third annular inserts which go to enclose the terminal edges 20a of the second series of the strip-like segments 14 brings about a particular strength of the bead without requiring an excessive radial development of the annular inserts themselves relative to the first annular insert. The reduced radial development of the second and third insert 24, 26 thus affords a space for the possible insertion of the auxiliary filling body 27 which can be provided, for instance to confer a greater strength and self-support capacity to the whole tyre.

The increase in structural strength in correspondence with the sidewalls has advantageously been obtained without entailing an excessive stiffening of the carcass structure in the crown, where the segments of the single ply carcass structure 3 are set circumferentially side by side in the absence of mutual superposition. This aspect is particularly advantageous with reference to high-performance tyres with lowered profile where the structure resistance of the sidewalls is a very critical item, also due to the high torque values the tyre must be able to transmit. High-performance tyres are typically suited for driving at high speeds, for example, at speeds greater than 200 km/h. Low-profile tyres have a reduced section ratio. The section ratio is calculated by dividing a section height by a section width. The section height is measured between a radially outermost point of the tread band and a radially innermost point of the bead. The section width is measured as a chord between two axially outermost points along a width of the tyre. Low-profile tyres generally have a section height which is less than about 60% of the section width.

FIGS. 8 and 10 illustrate a partial cross section of a first alternative tyre configuration without a filling body interposed between the first and second series of strip-like segments, and with the positions of the annular inserts relative to the ends of the strip-like segments modified. According to this aspect of the invention, the following advantages can be achieved by eliminating filling bodies altogether. First, the “quality” of the tyre may be improved. Despite its “filling” tasks, a filling body often provides undesired air inclusions within the tyre structure. This is particularly prone to occur if, in order to eliminate the production and storage of intermediate products, the filling body is obtained by winding a continuous strip of raw elastomer material directly on the tyre being manufactured. Air can be trapped between adjacent coils forming the filling body during winding and/or between such coils and other components of the tyre, e.g., ply strips, and annular reinforcing elements. Because the filling body is located at an innermost position of the bead of the tyre, the filling body is normally enveloped by a relatively thick material that prevents the trapped air from escaping the tyre structure during the manufacturing process. Thus, eliminating the filling body altogether overcomes the above drawbacks.

Second, the elimination of a filling body simplifies the construction of the tyre. Additional manufacturing steps and additional apparatuses for performing the additional steps are required for constructing the filling body. The filling body is normally formed by a compound which is different from that which is used in other parts of the tyre. Accordingly, the additional processing steps and apparatuses are not only those required for forming the filling body and assembling it with the other components of the tyre, but also for preparing the required compound and transforming it in the suitable form for being worked by the apparatuses provided along the tyre assembling line. Thus, eliminating the filling body from the tyre structure altogether also represents a remarkable simplification in the manufacturing process, in addition to improving tire quality. By eliminating the additional processing steps and apparatuses, productivity is enhanced and a corresponding reduction is manufacturing costs is advantageously achieved.

In the first alternative embodiment depicted in FIGS. 8 and 10, each of the pair of annular reinforcing structures includes a first annular insert 24 having opposed axial surfaces and being positioned between the respective lateral portions of the first series of strip segments 13 and the respective diverging lateral portions of the second series of strip segments 14, the opposed axial surfaces of the first annular insert 24 abutting the respective lateral portions of the first and second series of strip segments 13 and 14 in a double-ply carcass construction (FIG. 8) and in a single-ply construction (FIG. 10). Moreover, between a radially outermost end of the first annular insert 24 and the respective crown portions of the first and second series of strip segments 13 and 14, the diverging lateral portions of the second series of strip segments 14 are in overlapping contact with the lateral portions of the first series of strip segments 13. No separate filling body is positioned between the respective lateral portions of the first series of strip segments 13 and the respective diverging lateral portions of the second series of strip segments 14. In other words, in the first alternative embodiment, the respective lateral portions of the first series of strip segments 13 and the diverging lateral portions of the second series of strip segments 14 define a space 31 therebetween, and the opposed axial surfaces of the first annular insert 24 abut the respective lateral portions of the first and second series of strip segments 13 and 14, with the first annular insert 24 occupying essentially the entirety of the space 31.

In addition, each of the pair of annular reinforcing structures may optionally include a second annular insert 23 laterally opposed from the first annular insert 24 and positioned in conforming relation to, but axially inboard of, the respective lateral portions of the first series of strip segments 13, and may optionally include a third annular insert 26 laterally opposed from the first annular insert 24 and positioned in conforming relation to, and axially outboard of, the respective lateral portions of the second series of strip segments 14. Hence, while three annular inserts may be used in the first alternative embodiment, their positions relative to the end of the respective strip segments differ between the embodiments.

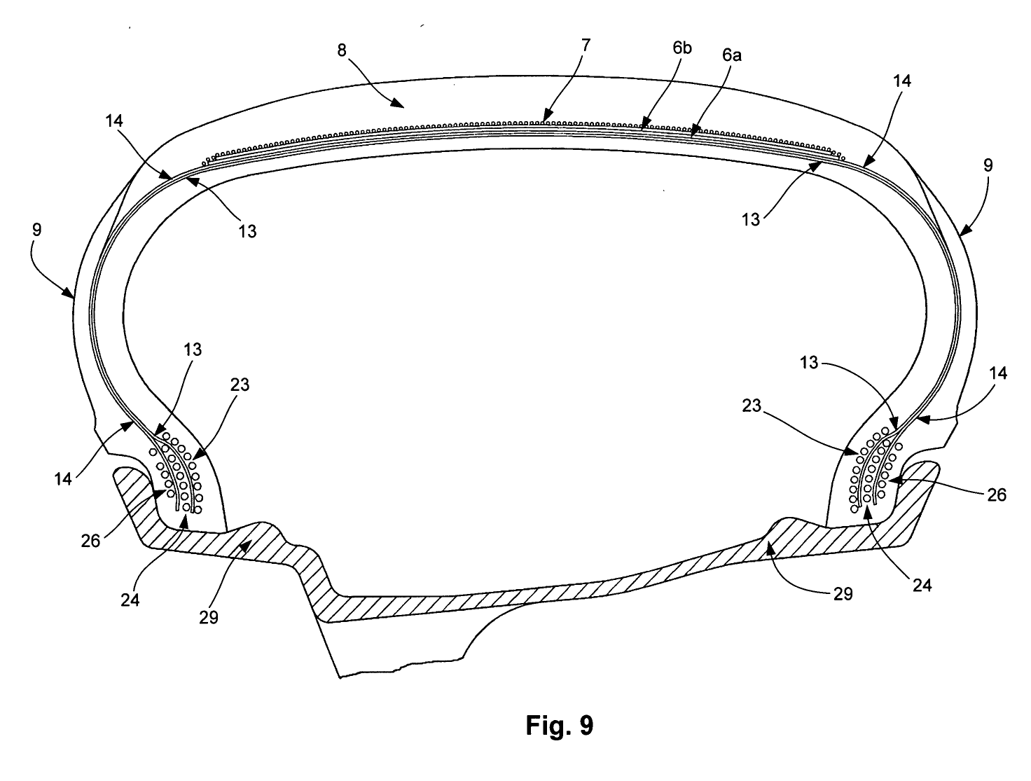

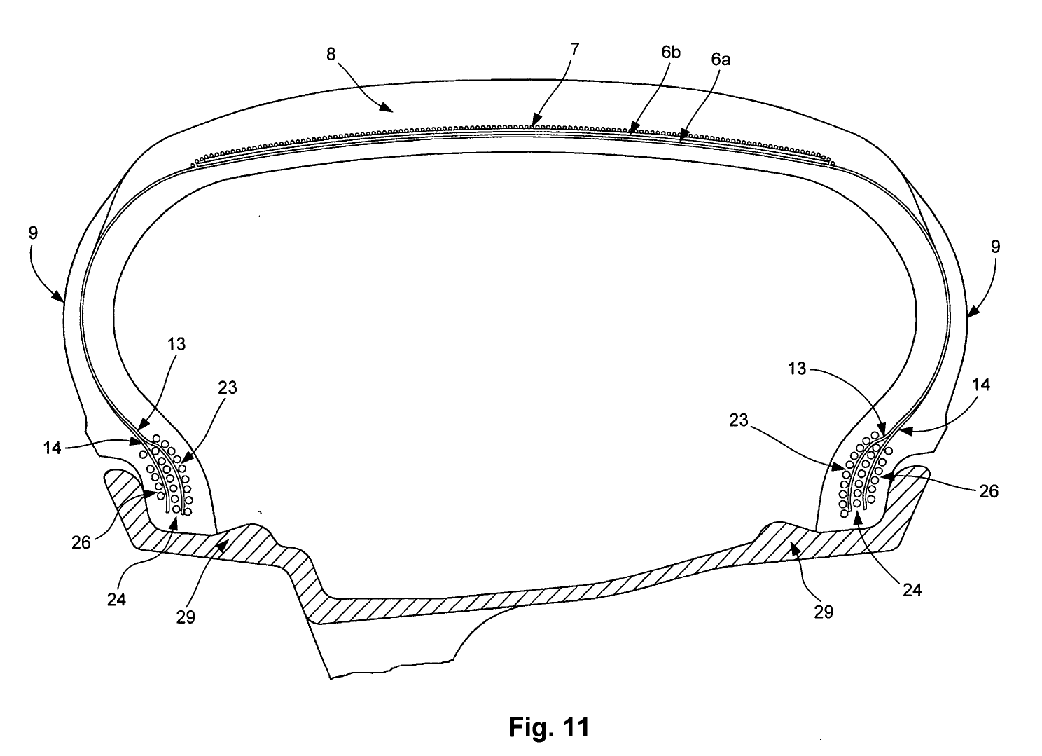

FIGS. 9 and 11 are cross sections of the first alternative tyre embodiment depicted in FIGS. 8 and 10, mounted on a rim section 29. When the tyre is mounted on the rim 29, an entirety of each of the pair of annular reinforcing structures extends substantially in a radial direction.

FIG. 9 also further illustrates the double-ply carcass structure shown in FIG. 8. In the double-ply carcass structure, the first and second series of strip segments 13 and 14 each form an individual ply and are superimposed on top of each other in a layered configuration. Such a configuration differs from a single-ply carcass structure, as described above and depicted in FIGS. 10 and 11, where the second series of strip segments 14 are interposed between the first series of strip segments 13.

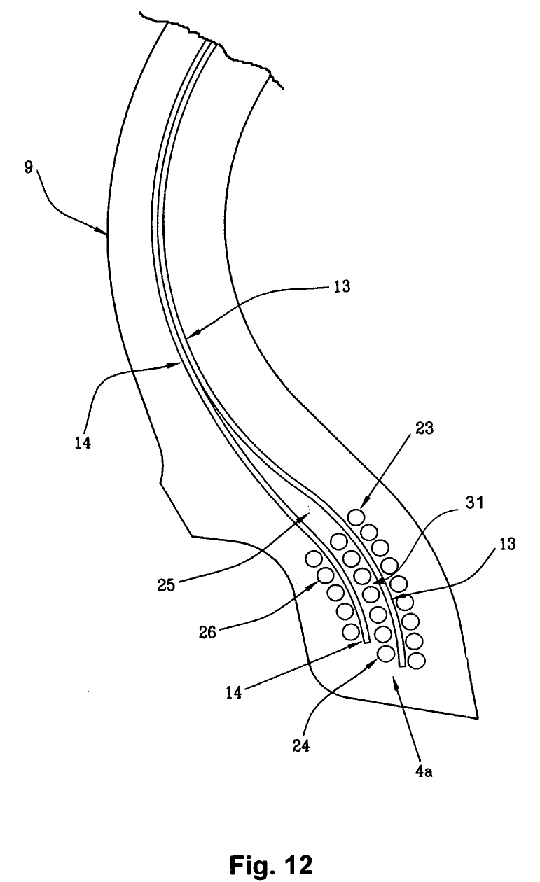

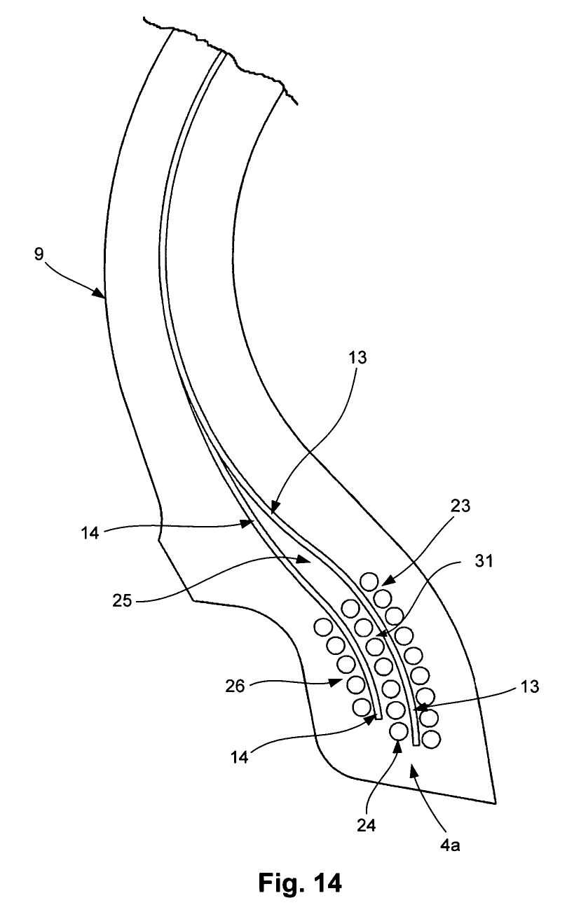

FIG. 12 and FIG. 14 are partial cross sections of a second alternative tyre configuration with a filling body and only one annular insert between the first and second series of strip-like segments in a double-ply carcass construction (FIG. 12) and in a single-ply construction (FIG. 14). In FIGS. 12 and 14, each of the pair of annular reinforcing structures includes a first annular insert 24 and a filling body 25, the first annular insert 24 and the filling body 25 each having opposed axial surfaces and being positioned between the respective lateral portions of the first series of strip segments 13 and the respective diverging lateral portions of the second series of strip segments 14. Furthermore, the respective opposed axial surfaces of the first annular insert 24 and the filling body 25 abut the respective lateral portions of the first and second series of strip segments 13 and 14. In other words, the respective lateral portions of the first series of strip segments 13 and the diverging lateral portions of the second series of strip segments 14 define a space 31 therebetween, and the respective opposed axial surfaces of the first annular insert 24 and the filling body 25 abut the respective lateral portions of the first and second series of strip segments 13 and 14. The first annular insert 24 and the filling body 25 essentially occupy the entirety of the space 31.

In addition, each of the pair of annular reinforcing structures may optionally include a second annular insert 23 laterally opposed from the first annular insert 24 and positioned in conforming relation to, and axially inboard of, the respective lateral portions of the first series of strip segments 13. The first annular insert 24 and the second annular insert 23 radially extend to terminal ends of the respective lateral portions of the first and second series of strip segments 13 and 14.

The second alternative embodiment may optionally include a third annular insert 26 laterally opposed from the first annular insert 24 and positioned in conforming relation to, and axially outboard of, the respective lateral portions of the second series of strip segments 14. Accordingly, while three annular inserts may be used in the second alternative embodiment, their positions relative to the end of the respective strip segments differ from the embodiments in FIGS. 1-7.

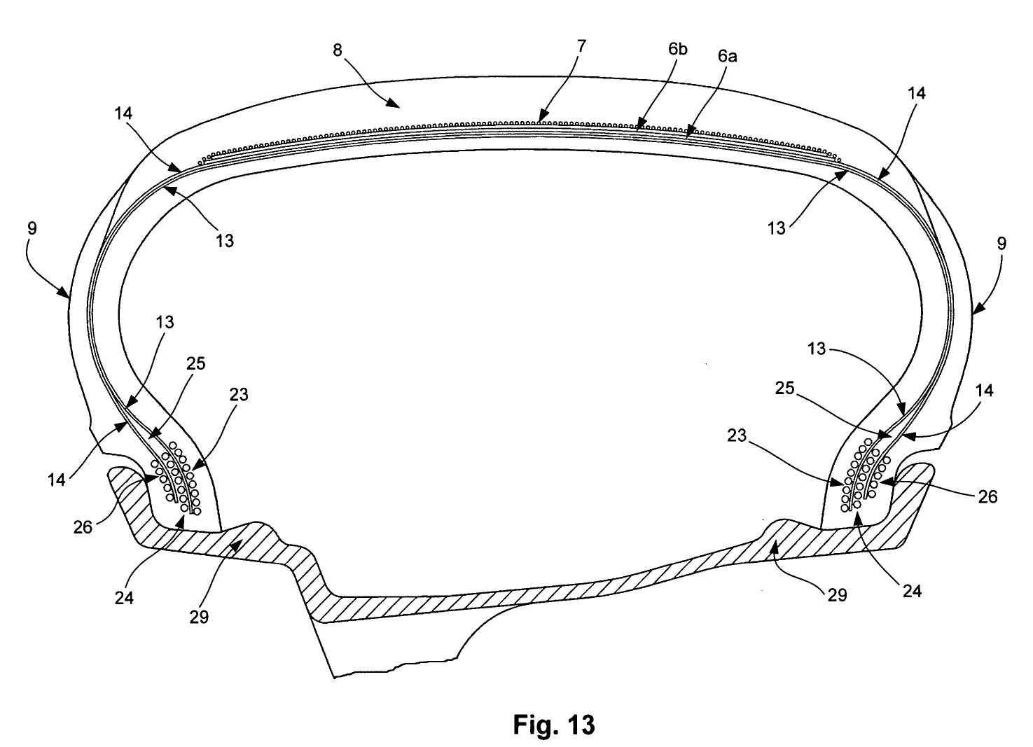

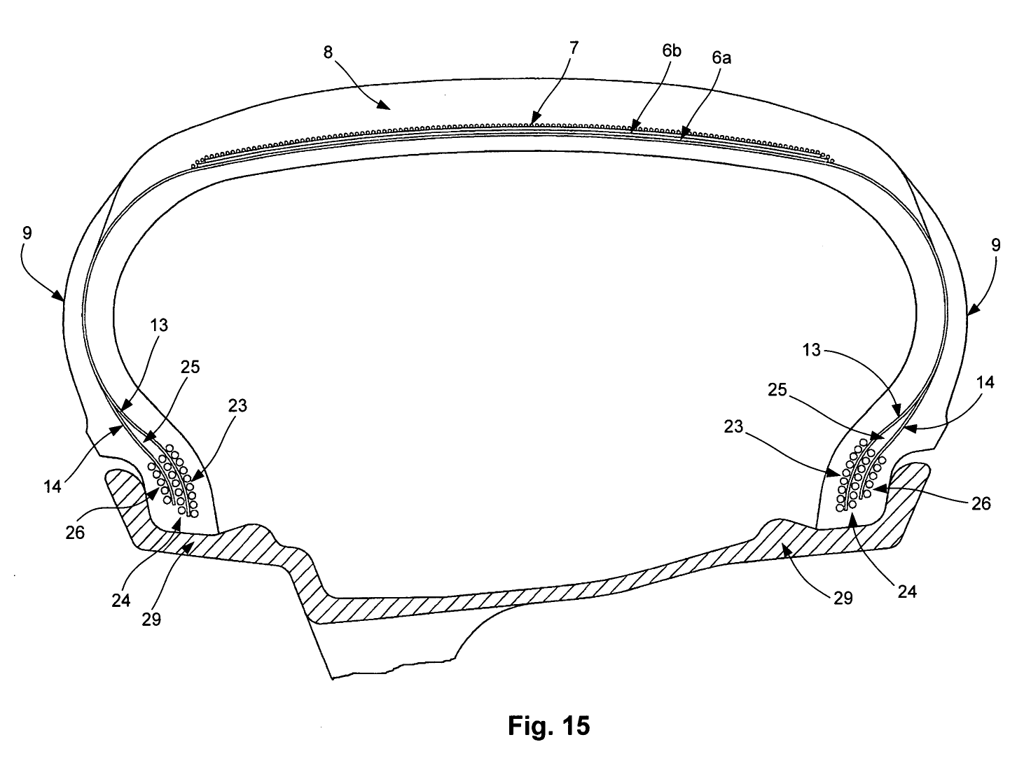

FIGS. 13 and 15 are cross sections of the second alternative tyre embodiment depicted in FIGS. 12 and 14, mounted on a rim section 29. When the tyre is mounted on the rim 29, an entirety of each of the pair of annular reinforcing structures extends substantially in a radial direction.

FIG. 13 also further illustrates the double-ply carcass structure shown in FIG. 12. In the double-ply carcass structure, the first and second series of strip segments 13 and 14 each form an individual ply and are superimposed on top of each other in a layered configuration. Such a configuration differs from a single-ply carcass structure, as described above and depicted in FIGS. 14 and 15, where the second series of strip segments 14 are interposed between the first series of strip segments 13.

What is claimed is:

1. A tyre for a vehicle wheel, the tyre having an axial direction and a circumferential direction, the tyre comprising:
a carcass structure having a generally U-shaped axial cross-section with axially opposed lateral portions;
a belt structure applied to the carcass structure at a circumferentially outer position of the carcass structure;
a tread band circumferentially superposed on the belt structure; and
sidewalls laterally applied to opposite sides of the carcass structure;
wherein the carcass structure comprises:
at least one carcass ply; and
a pair of annular reinforcing structures,
wherein the at least one carcass ply includes a first series of strip segments and a second series of strip segments, each of the strip segments of the first and second series having a crown portion interconnecting opposed lateral portions, respectively, the lateral portions of the second series of strip segments diverging axially outward from the respective lateral portions of the first series of strip segments,
wherein each of the pair of annular reinforcing structures includes a first annular insert having opposed axial surfaces and being positioned between the respective lateral portions of the first series of strip segments and the respective diverging lateral portions of the second series of strip segments, the opposed axial surfaces of the first annular insert abutting the respective lateral portions of the first and second series of strip segments, and
wherein between a radially outermost end of the first annular insert and the respective crown portions of the first and second series of strip segments, the diverging lateral portions of the second series of strip segments are in overlapping contact with the lateral portions of the first series of strip segments.

2. The tyre of claim 1, wherein each of the pair of annular reinforcing structures further includes a second annular insert laterally opposed from the first annular insert and positioned in conforming relation to, and axially inboard of, the respective lateral portions of the first series of strip segments.

3. The tyre of claim 2, wherein each of the pair of annular reinforcing structures further includes a third annular insert laterally opposed from the first annular insert and positioned in conforming relation to, and axially outboard of, the respective lateral portions of the second series of strip segments.

4. The tyre of claim 2, wherein the first annular insert comprises a radial extension greater than or equal to one-third and less than or equal to two-thirds of a radial extension of the second annular insert.

5. The tyre of claim 3, wherein the first annular insert and the third annular insert each comprise a radial extension smaller than a radial extension of the second annular insert.

6. The tyre of claim 3, wherein the third annular insert comprises a radial extension greater than or equal to one-third and less than or equal to two-thirds of a radial extension of the second annular insert.

7. The tyre of claim 3, wherein each of the first, second, and third annular inserts is substantially annulus-shaped, and formed by at least one elongated element extending in concentric turns.

8. The tyre of claim 1, further comprising:
a sealing layer disposed on an inner wall of the carcass structure.

9. The tyre of claim 1, wherein each of the first and second series of strip segments comprises at least two filiform elements at least partially coated by at least one layer of elastomer material.

10. The tyre of claim 1, wherein each of the pair of annular reinforcing structures is engaged in proximity to a respective inner circumferential edge of the at least one carcass ply.

11. The tyre of claim 1, wherein the tyre has a high-performance, low-profile configuration.

12. The tyre of claim 1, wherein the tyre is a motor-vehicle tyre.

13. The tyre of claim 1, wherein the tyre is a two-wheeled vehicle tyre.

14. The tyre of claim 1, wherein an entirety of each of the pair of annular reinforcing structures extends substantially in a radial direction when the tyre is mounted on the vehicle wheel.

15. The tyre of claim 1, wherein the carcass structure is a single-ply carcass structure.

16. The tyre of claim 1, wherein the carcass structure is a double-ply carcass structure.

17. A tyre for a vehicle wheel, the tyre having an axial direction and a circumferential direction, the tyre comprising:
a carcass structure having a generally U-shaped axial cross-section with axially opposed lateral portions;
a belt structure applied to the carcass structure at a circumferentially outer position of the carcass structure;
a tread band circumferentially superposed on the belt structure; and
sidewalls laterally applied to opposite sides of the carcass structure;
wherein the carcass structure comprises:
at least one carcass ply; and
a pair of annular reinforcing structures,
wherein the at least one carcass ply includes a first series of strip segments and a second series of strip segments, each of the strip segments of the first and second series having a crown portion interconnecting opposed lateral portions, respectively, the lateral portions of the second series of strip segments diverging axially outward from the respective lateral portions of the first series of strip segments,
wherein each of the pair of annular reinforcing structures includes a first annular insert having opposed axial surfaces and being positioned between the respective lateral portions of the first series of strip segments and the respective diverging lateral portions of the second series of strip segments, the opposed axial surfaces of the first annular insert abutting the respective lateral portions of the first and second series of strip segments, and
wherein no filling body is positioned between the respective lateral portions of the first series of strip segments and the respective diverging lateral portions of the second series of strip segments.

18. A tyre for a vehicle wheel, the tyre having an axial direction and a circumferential direction, the tyre comprising:
a carcass structure having a generally U-shaped axial cross-section with axially opposed lateral portions;
a belt structure applied to the carcass structure at a circumferentially outer position of the carcass structure;
a tread band circumferentially superposed on the belt structure; and
sidewalls laterally applied to opposite sides of the carcass structure;
wherein the carcass structure comprises:
at least one carcass ply; and
a pair of annular reinforcing structures,
wherein the at least one carcass ply includes a first series of strip segments and a second series of strip segments, each of the strip segments of the first and second series having a crown portion interconnecting opposed lateral portions, respectively, the lateral portions of the second series of strip segments diverging axially outward from the respective lateral portions of the first series of strip segments,
wherein each of the pair of annular reinforcing structures includes a first annular insert having opposed axial surfaces, and
wherein the respective lateral portions of the first series of strip segments and the diverging lateral portions of the second series of strip segments define a space therebetween, the opposed axial surfaces of the first annular insert abutting the respective lateral portions of the first and second series of strip segments, the first annular insert occupying essentially the entirety of the space.

19. A tyre for a vehicle wheel, the tyre having an axial direction and a circumferential direction, the tyre comprising:
a carcass structure having a generally U-shaped axial cross-section with axially opposed lateral portions;
a belt structure applied to the carcass structure at a circumferentially outer position of the carcass structure;
a tread band circumferentially superposed on the belt structure; and
sidewalls laterally applied to opposite sides of the carcass structure;
wherein the carcass structure comprises:
at least one carcass ply; and
a pair of annular reinforcing structures,
wherein the at least one carcass ply includes a first series of strip segments and a second series of strip segments, each of the strip segments of the first and second series having a crown portion interconnecting opposed lateral portions, respectively, the lateral portions of the second series of strip segments diverging axially outward from the respective lateral portions of the first series of strip segments,
wherein each of the pair of annular reinforcing structures includes a first annular insert and a filling body, the first annular insert and the filling body each having opposed axial surfaces and being positioned between the respective lateral portions of the first series of strip segments and the respective diverging lateral portions of the second series of strip segments, the respective opposed axial surfaces of the first annular insert and the filling body abutting the respective lateral portions of the first and second series of strip segments, and
wherein an entirety of each of the pair of annular reinforcing structures extends substantially in a radial direction when the tyre is mounted on the vehicle wheel.

20. The tyre of claim 19, wherein each of the pair of annular reinforcing structures further includes a second annular insert laterally opposed from the first annular insert and positioned in conforming relation to, and axially inboard of, the respective lateral portions of the first series of strip segments.

21. The tyre of claim 20, wherein the first annular insert and the second annular insert radially extend to terminal ends of the respective lateral portions of the first and second series of strip segments.

22. The tyre of claim 20, wherein each of the first and second annular inserts is substantially annulus-shaped, and formed by at least one elongated element extending in concentric turns.

23. The tyre of claim 20, wherein the first annular insert comprises a radial extension greater than or equal to one-third and less than or equal to two-thirds of a radial extension of the second annular insert.

24. The tyre of claim 19, wherein each of the pair of annular reinforcing structures further includes a third annular insert laterally opposed from the first annular insert and positioned in conforming relation to, and axially outboard of, the respective lateral portions of the second series of strip segments.

25. The tyre of claim 24, wherein the third annular insert is substantially annulus-shaped, and formed by at least one elongated element extending in concentric turns.

26. The tyre of claim 19, wherein each of the first and second series of strip segments comprises at least two filiform elements at least partially coated by at least one layer of elastomer material.

27. The tyre of claim 19, wherein each of the pair of annular reinforcing structures is engaged in proximity to a respective inner circumferential edge of the at least one carcass ply.

28. The tyre of claim 19, wherein the filling body is made of elastomeric material.

29. The tyre of claim 19, wherein the tyre has a high performance, low-profile configuration.

30. The tyre of claim 19, wherein the tyre is a motor-vehicle tyre.

31. The tyre of claim 19, wherein the tyre is a two-wheeled vehicle tyre.

32. The tyre of claim 19, further comprising:
a sealing layer disposed on an inner wall of the carcass structure.

33. The tyre of claim 19, wherein the carcass structure is a single-ply carcass structure.

34. The tyre of claim 19, wherein the carcass structure is a double-ply carcass structure.

35. The tyre of claim 19, wherein each of the pair of annular reinforcing structures further includes a second annular insert laterally opposed from the first annular insert and positioned in conforming relation to, and axially inboard of, the respective lateral portions of the first series of strip segments, and
a third annular insert laterally opposed from the first annular insert and positioned in conforming relation to, and axially outboard of, the respective lateral portions of the second series of strip segments.

36. A tyre for a vehicle wheel, the tyre having an axial direction and a circumferential direction, the tyre comprising:
a carcass structure having a generally U-shaped axial cross-section with axially opposed lateral portions;
a belt structure applied to the carcass structure at a circumferentially outer position of the carcass structure;
a tread band circumferentially superposed on the belt structure; and
sidewalls laterally applied to opposite sides of the carcass structure;
wherein the carcass structure comprises:
at least one carcass ply; and
a pair of annular reinforcing structures,
wherein the at least one carcass ply includes a first series of strip segments and a second series of strip segments, each of the strip segments of the first and second series having a crown portion interconnecting opposed lateral portions, respectively, the lateral portions of the second series of strip segments diverging axially outward from the respective lateral portions of the first series of strip segments,
wherein each of the pair of annular reinforcing structures includes a first annular insert and a filling body, the first annular insert and the filling body each having opposed axial surfaces,
wherein the respective lateral portions of the first series of strip segments and the diverging lateral portions of the second series of strip segments define a space therebetween, the respective opposed axial surfaces of the first annular insert and the filling body abutting the respective lateral portions of the first and second series of strip segments, the first annular insert and the filling body occupying essentially the entirety of the space, and
wherein an entirety of each of the pair of annular reinforcing structures extends substantially in a radial direction when the tyre is mounted on the vehicle wheel.
